(19) United States
(12) Patent Application Publication
(10) Pub. No.: US 2006/0095896 A1
(43) Pub. Date: May 4, 2006

(54) Apparatus, system, and method of removing exception related dependencies

(76) Inventors: Jianhui Li, Shanghai (CN); Orna Etzion, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/950,675

(22) Filed: Sep. 28, 2004

(51) Int. Cl. G06F 9/45

(52) U.S. Cl. 717/136

(57) ABSTRACT

A set of source instructions that complies with a source architecture is dynamically translated into a set of target instructions that complies with a target architecture. At least some of exception-related dependencies between faulty instructions and their immediate preceding instructions, in the translated target instruction binary code, are removed. Instead, dependencies between mapping registers and their representative registers that are associated with the faulty instructions are created. Computations of the values of mapping registers, for the recovery of canonical registers, are delayed until exceptions are actually detected during execution of the target instructions. The restoration of context of source instructions at the exception-related recovery points is realized through the invoking of associated recovery functions.

### BACKGROUND OF THE INVENTION

Translation software may be used to translate a source binary code, which complies with a source processor architecture having a source instruction set, into a target binary code that complies with a target processor architecture having a target instruction set. The target binary code may then be executed on the target processor.

During translation, a dynamic optimizer may optimize frequently executed blocks of instructions, in order to produce the fastest running code on the target platform, by generating intermediate representatives, constructing dependencies between the generated representatives, performing scheduling of instructions, and finally producing a target binary code. One constraint of dynamic optimization is a difficulty in providing a consistent source instruction context when exceptions are detected in the optimized target code during execution. In order to provide such context, all instructions that are needed in order to update the context of the exception must be executed before executing the instruction that may cause the exception. A scheduler may achieve this by maintaining special dependencies between translated instructions that may be used to update the source instruction context, and instructions that may cause exceptions in the target context. However, this kind of exception related dependencies impose constraints on the scheduler on moving instructions around when necessary, and so often leads to a less-optimized target code.

### BRIEF DESCRIPTION OF THE DRAWINGS

The invention will be understood and appreciated more fully from the following detailed description of embodiments of the invention, taken in conjunction with the accompanying drawings of which:

FIG. 1 is a block diagram illustration of an apparatus capable of translating instructions from a source architecture to a target architecture according to some exemplary embodiments of the invention;

FIG. 2 is a conceptual illustration of a dependency chain structure according to exemplary embodiments of the present invention, showing changes relative to a corresponding conventional dependency chain structure;

FIG. 3 is a schematic flowchart of a method of generating intermediate representations for exception-related faulty points according to some exemplary embodiments of the invention;

FIG. 4 is a schematic flowchart of a method of constructing exception-related dependencies according to some exemplary embodiments of the invention; and

FIG. 5 is a schematic illustration of a method of restoring source instruction context upon detection of exceptions during execution of target instructions according to some exemplary embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods and procedures have not been described in detail so as not to obscure the embodiments of the invention.

Some portions of the detailed description in the following are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Some embodiments of the invention may be implemented, for example, using a machine-readable medium or article which may store an instruction or a set of instructions that, if executed by a machine, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, e.g., memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Embodiments of the invention may include apparatuses for performing the operations herein. These apparatuses may be specially constructed for the desired purposes, or they may include a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROM), random access memories (RAM), electrically programmable read-only memories (EPROM), electrically erasable and programmable read only memories (EEPROM), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the invention are not described with reference to any particular programming language. It will be appreciated that a variety of programming languages may be used to implement the teachings of the invention as described herein.

In the following description, various figures, diagrams, flowcharts, models, and descriptions are presented as different means to effectively convey the substances and illustrate different embodiments of the invention that are proposed in this application. It shall be understood by those skilled in the art that they are provided merely as exemplary samples, and shall not be constructed as limitation to the invention.

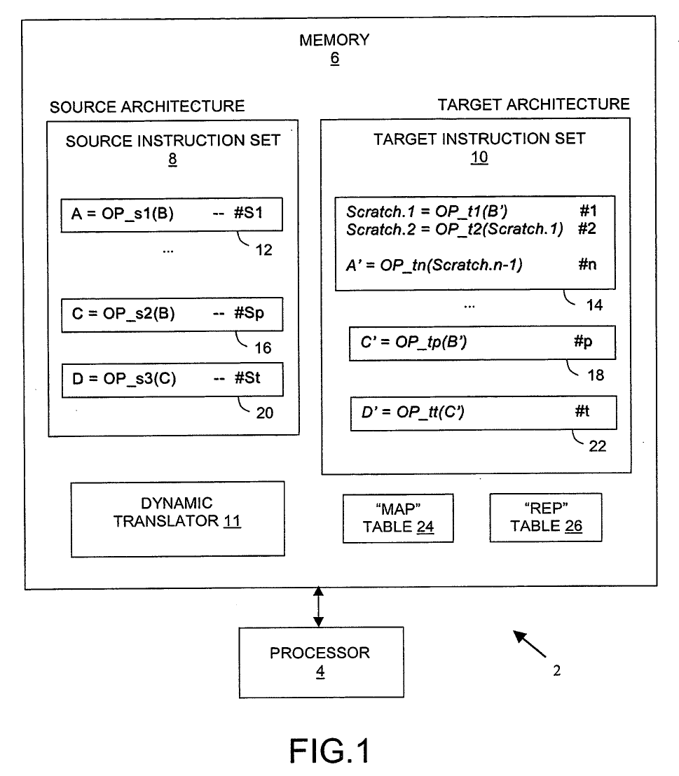

FIG. 1 is a block diagram illustration of an apparatus 2, for example, a computing platform, including a processor 4 operatively connected to at least one memory 6, which may be capable of storing a source instruction set 8 and a target instruction set 10, according to exemplary embodiments of the invention. Computing platform 2 may be capable of translating source instruction set 8, which complies with a desired source architecture, into target instruction set 10, which complies with a desired target architecture, e.g., using principles as described below in conjunction with exemplary embodiments of the invention. Apparatus 2 may further include a dynamic translator 11 which translates source instruction set 8 into target instruction set 10, as described below in more detail.

A non-exhaustive list of examples for apparatus 2 includes a desktop personal computer, a work station, a server computer, a laptop computer, a notebook computer, a hand-held computer, a personal digital assistant (PDA), a mobile telephone, a game console, and the like.

A non-exhaustive list of examples for processor 4 includes a central processing unit (CPU), a digital signal processor (DSP), a reduced instruction set computer (RISC), a complex instruction set computer (CISC) and the like. Moreover, processor 4 may be part of an application specific integrated circuit (ASIC) or may be a part of an application specific standard product (ASSP).

Memory 6 may be fixed within or removable from apparatus 2. A non-exhaustive list of examples for memory 6 includes one or any combination of the following:
semiconductor devices, such as
   synchronous dynamic random access memory (SDRAM) devices, RAMBUS dynamic random access memory (RDRAM) devices, double data rate (DDR) memory devices, static random access memory (SRAM), flash memory devices, electrically erasable programmable read only memory devices (EEPROM), non-volatile random access memory devices (NVRAM, universal serial bus (USB) removable memory, and the like;
optical devices, such as
   compact disk read only memory (CD ROM), and the like;
and magnetic devices, such as
   a hard disk, a floppy disk, a magnetic tape, and the like.

Processor 4 may execute target instruction set 10. A non-limiting example for the target architecture is the Intel® architecture-64 (IA-64). Memory 6 may store, as part of source instructions, source instruction set 8. A non-limiting example for the source architecture is the Intel® architecture-32 (IA-32). If the source architecture does not comply with the target architecture, as is the case, for example, with the IA-32 and IA-64 architectures, processor 4 may not be able to execute the set of source instructions.

Processor 4 may be adapted to run a dynamic translator 11, which may be used to translate source instruction set 8 into target instruction set 10. Once source instruction set 8 is translated into target instruction set 10, processor 4 may execute target instruction set 10. The results of processing instruction set 10 may generally correspond to the results of executing source instruction set 8 on a processor that complies with the source architecture.

During translation of source instruction set 8 into target instruction set 10, it is assumed that processor 4, by running dynamic translator 11, may translate a single source instruction 12 (#S1) into a target sub-set 14 of target instructions 10. Target sub-set 14 may contain multiple instructions, denoted symbolically by #1, #2 . . . and #n, wherein one or more higher numbered instructions may depend from one or more lower numbered instructions.

Similarly, dynamic translator 11 may proceed to translate source instruction 16 (#Sp) into target instruction 18 (#p) and source instruction 20 (#St) into target instruction 22 (#t).

For the illustrative example shown in FIG. 1, target instruction #2 of sub-set 14 depends from target instruction #1 of sub-set 14, and target instruction #1 of sub-set 14 depends from a target instruction (not shown) that produces a register B′, and referred herein as “instruction #0”. Register B′ corresponds to a register B in source instruction 12. In other words, target instruction #1 of sub-set 14 produces an intermediate register, denoted “Scratch.1”, and provides the intermediate register “Scratch.1” to instruction #2 of sub-set 14.

Similarly, in this example, target instruction #n of sub-set 14 operates on an intermediate register “Scratch.n-1”, produced by a preceding instruction (not shown), which may or may not be an instruction immediately preceding instruction #n in sub-set 14. Target instruction #n produces a register A′, which corresponds to a register A in source instruction 12. Therefore, target instruction #n may be referred to herein as the producer of A′.

Registers A and B in source instruction 12 of source instruction set 8 may be referred to herein as “canonical registers”. Registers A′ and B′ in the target sub-set 14, which is the translation of source instruction 12 of target instruction set 10, may be referred to as “mapping registers” of registers A and B, respectively.

Instructions in the target architecture may raise exceptions. For example, both Intel® IA-32 and IA-64 architectures support the following specific exceptions: “invalid operation”, “division by zero”, “overflow”, “underflow” and “inexact calculation” floating point exceptions, as defined and required in the ANSI/IEEE standard 754-1985 for binary floating-point arithmetic, and a “denormal operand” floating point exception.

A target instruction that may potentially raise exception is referred to as a “faulty instruction”. A point associated with a faulty instruction in the target instruction set is referred to as a “faulty point”. For each faulty instruction, there may be a corresponding point in the source instruction set, which corresponding point may be referred to as a “recovery point”. For example, there may be a faulty point at faulty instruction #p in target instruction set 10. The corresponding recovery point of faulty instruction #p in source instruction set 8 may be at source instruction #Sp. It will be appreciated that in the translation shown, it is assumed that the instruction that results in canonical register A is exclusively #S1, i.e., there are no other instructions that may also result in writing to register A between instruction #S1 and #Sp. Therefore, in order to recover a correct value of register A when an exception occurs at faulty instruction #p, an exception-related dependency should be built between target instructions #n and #p. This may prevent the scheduling of instruction #p before instruction #n. In other words, instruction #n is executed to produce the value of mapping register A′ before the exception is raised at instruction #p.

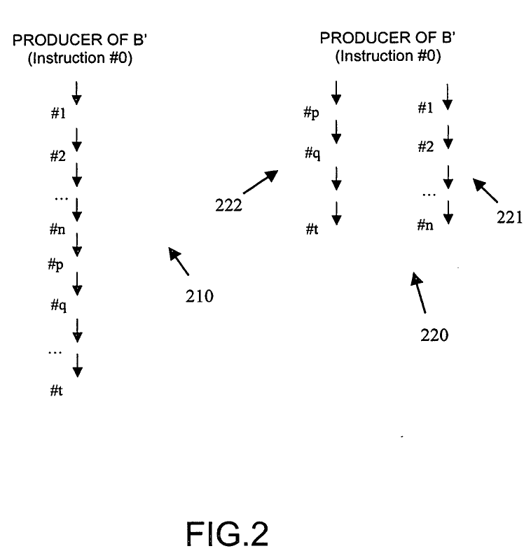

FIG. 2 is a conceptual illustration of two exemplary dependency chain structures according to embodiments of the invention. The notations #1, #2, #n, #p, #q, and #t in FIG. 2 correspond to the same notations in FIG. 1, and denote different target instructions. Arrows in between the instructions in FIG. 2 represent relations of data dependency between illustrated target instructions. The “producer” of B′ in FIG. 2 refers to an instruction (not shown) that precedes instruction #1 and produces register B′.

As discussed above and shown in FIG. 2, in order to calculate the value of mapping register A′ before an exception may be raised, e.g., at instruction #p, data dependency should be maintained between target instructions #n and #p at the potential faulty instruction #p. As a result, all the instructions from #1 to #n may form a part of a dependency chain 210, which extends from instruction #1 through instruction #n and instruction #p, and finally to instruction #t. This relatively long dependency chain may prevent a scheduler from producing an optimal target binary code because of the need to maintain this long data dependency. The produced target instruction code may consequently incur cost in the form of lost parallel execution.

According to some embodiments of present invention, a canonical register may be recovered from one or more representative registers, as compared from a corresponding mapping register as is known in the art. A representative register is a register or one of a number of registers from which a canonical register may be restored through a recovery function. Register B′ may be, for example, a representative register of canonical register A, because mapping register A′, whose value is the same as that of canonical register A, may be restored from register B′ based on target sub-set 14 when an exception occurs at instruction #p. According to exemplary embodiments of the invention, a dependency of instruction #p may be constructed from instruction #0, that produces register B′, instead of from instruction #n. As shown in FIG. 2, a dependency chain structure 220 may be constructed, wherein a dependency chain 221 and a dependency chain 222 branches out at instruction #0. Dependency chain 221 denotes the data dependency from instruction #1 to instruction #n, and dependency chain 222 denotes the data dependency from instruction # to instruction #t.

The representative relation between a canonical register and one or more representative registers, for example, A and B′, may be referred to herein as a “representation”. A function that may be used to calculate the value of mapping register A′ from representative register B′, for example, target sub-set 14, may be referred to herein as a “recovery function”.

According to some embodiments of the present invention, a calculation of the value of mapping register A′ for the recovery of canonical register A may be delayed until an actual exception is detected, e.g., at instruction #p, during execution of target instruction set 10. This is because the execution of instruction #p, when an exception occurs, is no longer dependent on the preceding instruction #n and the related register A′. Rather, the execution of instruction #p may be dependent on instruction #0 that produces register B′. In other words, the exception-related dependency from instruction #n to instruction #p becomes inconsequential to the execution of instruction #p.

In FIG. 2, dependency chain structure 220 is shown to include two dependency chains, e.g., dependency chains 221 and 222. The reduced dependency chain lengths of dependency chain structure 220 are appreciated by comparing the length of dependency chains 221 and 222 with the length of dependency chain 210, which corresponds to a concatenation of dependency chains 221 and 222. It is thus clear that by constructing dependency chain structure 220 to replace dependency chain 210, a significant reduction in dependency chain length may be achieved. In addition, the two dependency chains, namely 221 from #1 to #n, and 222 from #p to #t, may be executed independently and in parallel. This is particularly useful since some target machines are known to be capable of executing multiple instructions in one cycle. The parallel and independent execution of dependency chains may improve system efficiency in terms of instruction level parallelism (ILP) as measured by shorted execution time.

Furthermore, if register A′ is abandoned after instruction #p because no other instructions thereafter make reference to A′, or if instructions for calculating register A′ are needed only for recovering canonical register A in case of an exception at #p, then target instructions from #1 to #n, may not need to be executed and therefore may be deleted. The deletion of target instructions from #1 to #n not only reduces the overall complexity of the dependency chain in the target instructions but may also result in a simpler and shorter computer code to be executed.

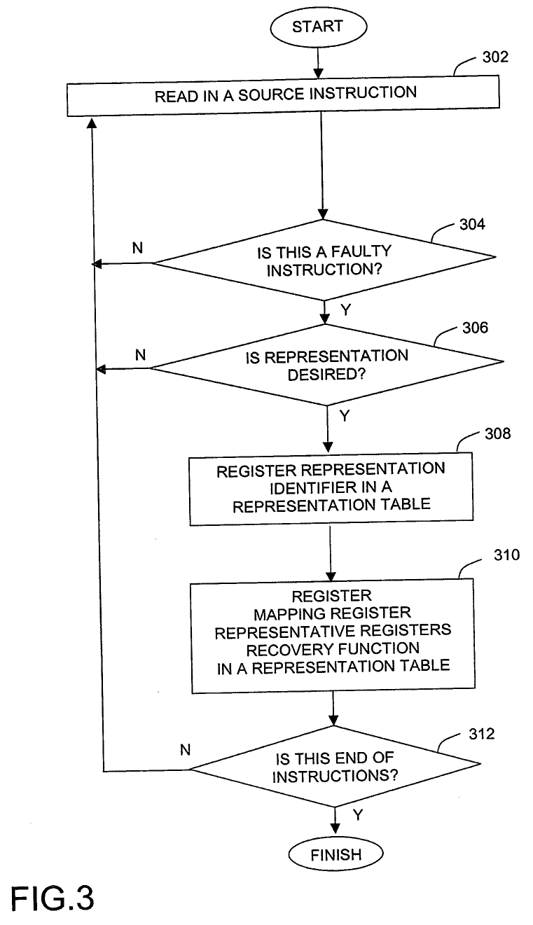

FIG. 3 schematically illustrates a method of generating exception-related intermediate representations (IR), e.g., using dynamic translator 11, to associate a faulty point with a recovery point related with an exception, according to some exemplary embodiments of the invention. The intermediate representations may be used in a subsequent procedure of constructing dependency chains for the target instruction set with exception-related dependencies removed.

Dynamic translator 11 may start generating intermediate representations by reading a source instruction (block 302). If the translated target instruction is not a faulty instruction, translator 11 may return to block 302 and proceed to read the next source instruction. This process may be repeated until translator 11 identifies a faulty instruction by comparing with a pre-defined internal list (block 304). Translator 11 may then determine whether constructing a representation for the faulty point is desirable (block 306). There may be cases where constructing a representation may not be ideal, for example, if the associated recovery function is relatively simple, as compared with constructing an intermediate representation.

If constructing a representation for the faulty point is desired at block 306, translator 11 may assign a representation identifier (ID) to the faulty point and register the representation ID, referred to herein as “RID”, in a representation table (block 308). The representation table, referred to herein as “rep table”, may be a look-up table and is denoted “rep table” 26 in FIG. 1. Translator 11 may also relate the representation ID with a recovery function, a mapping register, and one or more representative registers associated with the mapping register. The relating may be through registration in the rep table (block 310). In other words, all the elements that may be necessary for source context recovery at the faulty point, namely, the RID, the mapping register, one or more of the representative registers, and the recovery function, may be recorded in the rep table. The recovery function is a function that may receive as input representative registers and may output values of corresponding mapping registers, which may then be used as values of corresponding canonical registers.

The construction process may determine whether the end of an instruction set has been reached (block 312). If the end of the instruction set is not reached, the process of constructing intermediate representation may return back to the beginning (block 302) and may proceed to read a new source instruction.

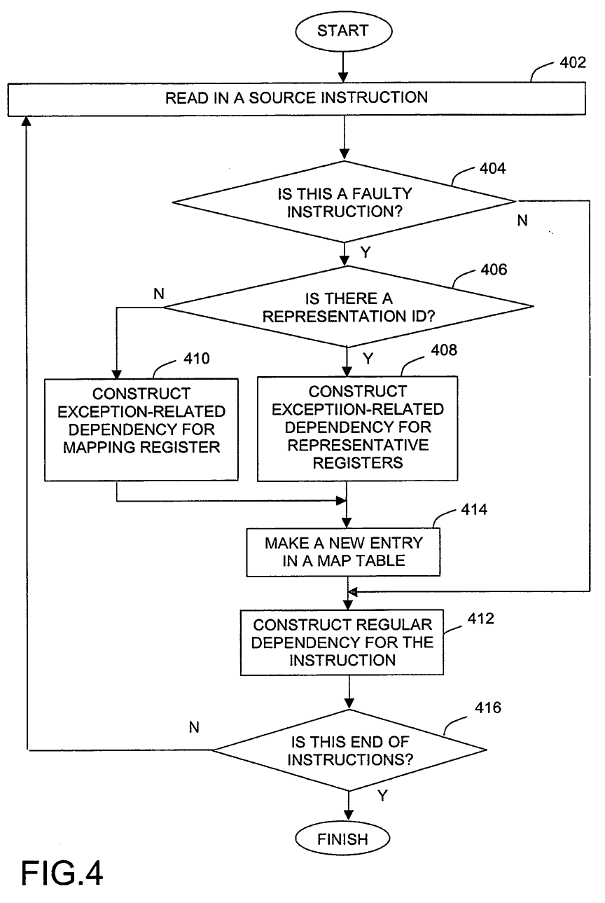

FIG. 4 schematically illustrates a method of constructing dependency for the target instructions and removing exception-related dependencies, according to exemplary embodiments of the invention.

Dynamic translator 11 may start constructing dependency of target instructions by reading a source instruction (block 402). Next, at block 404, translator 11 may determine whether a target instruction translated from the source instruction is a faulty instruction. If the target instruction is not a faulty instruction, translator 11 may construct a dependency for a mapping register associated with the target instruction (block 412), and may proceed to verify whether the end of a source instruction set has been reached (block 416). If there are more source instructions to be translated, translator 11 may return to block 402 and proceed to read the next source instruction.

If dynamic translator 11 identifies the target instruction as a faulty instruction at block 404, translator 11 may proceed to determine if there is a RID associated with this faulty instruction at this faulty point at block 406. If there is no RID at this faulty point, for example, when constructing an IR is determined to be not desirable during the IR constructing process at block 306 of FIG. 3, translator 11 may proceed to construct an exception-related dependency for a mapping register associated with the faulty instruction (block 410). Next, translator 11 may record instruction pointers of both the faulty point of target instruction, e.g., #p as in FIG. 1, and the recovery point of source instruction, e.g., #Sp as in FIG. 1, as a new entry in a map table (block 414) and proceed to construct regular dependency for the instruction (block 412). If the map table does not exist, a new map table may be created. This is different from the situation when the target instruction is not a faulty instruction wherein no entry is made in the map table.

A map table as described herein may be used to associate one or more exception-related faulty points of the target instruction set with one or more recovery points of the source instruction set, respectively. Each entry of the map table may contain at least two elements, namely, an instruction pointer (IP) of the faulty point and an instruction pointer of the recovery point, wherein both the IP and recovery point are related with the faulty instruction. The entry of the map table may also contain a third element of a valid RID that may be associated with a RID in the “rep table”, which may be created during the process of constructing intermediate representations, as described above with reference to FIG. 3. Furthermore, during the execution of target instruction, e.g., a target binary code, the map table may be referenced for recovering a source instruction context at faulty points as described in detail below.

Translator 11 may not construct a dependency, at an exception-related faulty point, for a mapping register, e.g., register A′, but instead may construct a dependency for one or more representative registers, e.g., register B′, associated with this faulty point (block 408). This is the case when dynamic translator 11 identifies a target instruction as a faulty instruction (block 404), and at the same time also identifies that there is a RID associated with the faulty instruction (block 406) during the dependency constructing process. Translator 11 may further proceed to record in the map table instruction pointers of both the faulty point of the target instruction and the recovery point of the source instruction as well as the RID (block 414), and construct regular dependency for the instruction (block 412).

There may be situations where the optimization process identifies that the canonical register of a representation is abandoned beyond the point of a faulty instruction or before being used by any subsequent instructions. These situations may occur as a result of some optimization procedure such as scheduling of instructions. Then, the removal of this exception-related dependency may provide an additional benefit, namely, instructions related to the canonical register may be deleted completely to result in a much simpler dependency chain structure. For example, in the exemplary dependency chain structure shown in FIG. 2, the dependency chain from instruction #1 to instruction #n, which branches out at instruction #0, may be deleted completely.

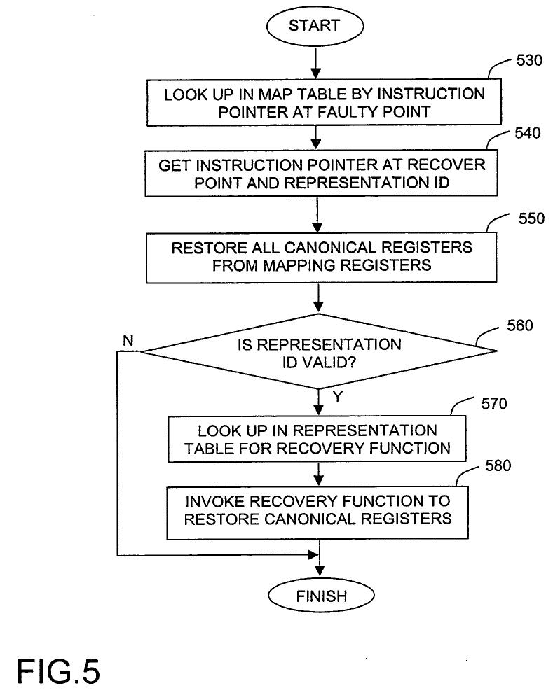

FIG. 5 schematically illustrates a method of restoring context of source instructions, when an exception is raised during execution of target instructions, according to some exemplary embodiments of this invention.

Translator 11 may first look up in the map table using an instruction pointer (IP) of the faulty point (block 530). From the map table, translator 11 may retrieve the instruction pointer (IP) of the recovery point, for example, instruction #Sp, associated with the faulty point, for example, instruction #p, and possibly a valid RID (block 540) if there is a representation associated with this faulty point.

Translator 11 may then perform an initial set of routines, as are known in the art, to restore the context of source instruction set 8 by associating values of the set of mapping registers to their corresponding set of canonical registers, e.g., by applying values of the set of mapping registers to their corresponding set of canonical registers (block 550). Next, translator 11 may look at the RID hereafter, which may be retrieved from the map table at block 540, and may determine for the validity of the RID at block 560.

If it is confirmed that the RID is a valid RID, meaning that there is a valid representation between the canonical register, for example, A, and associated representative register, for example, B′, translator 11 may then look up in the rep table, using the RID as an entry, to identify a recovery function at block 570. In the following operations, the recovery function may be invoked to associate the value of a mapping register with the value of one or more representative registers (block 580). That is, the value of the. mapping register, e.g., A′, may be calculated from the representative register, e.g., B′, and the canonical register, e.g., A, may be updated with the value of mapping register, e.g., A′, by applying mapping register A′ to canonical register A.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. A method comprising associating one or more faulty points of a set of target instructions with one or more respective recovery points of a set of source instructions.

2. The method of claim 1, comprising branching out one or more dependency chains of said set of target instructions at one or more of said faulty points, respectively.

3. The method of claim 1, comprising translating said set of source instructions into said set of target instructions.

4. The method of claim 1, wherein associating comprises relating one or more instruction pointers of said faulty points with one or more respective instruction pointers of said recovery points.

5. The method of claim 1, wherein associating comprises relating one or more registers at said faulty points with one or more respective registers at said recovery points.

6. The method of claim 5, wherein relating comprises applying values of one or more registers at said faulty points to one or more, respective, registers at said recovery points.

7. The method of claim 1, wherein associating comprises:
relating one or more of a first set of registers at said faulty points with one or more respective registers at said recovery points; and
relating a second set of registers at said faulty points with one or more of said first set of registers through one or more, respective, recovery functions.

8. The method of claim 7, wherein associating comprises:
calculating values of one or more of said first set of registers from said second set of registers; and
applying said values to one or more, respective, registers at said recovery points.

9. The method of claim 7, comprising relating one or more of said recovery functions to one or more, respective, representation identifiers.

10. An apparatus, comprising:
a translator to translate a set of source instructions having one or more recovery points into a set of target instructions having one or more faulty points, which are associated with said one or more recovery points, respectively.

11. An apparatus according to claim 10, wherein said translator is able to branch out one or more dependency chains of said set of target instructions at one or more of said faulty points, respectively.

12. An apparatus according to claim 10, wherein said translator is able to relate one or more registers at said faulty points to one or more, respective, registers at said recovery points.

13. An apparatus according to claim 12, wherein said translator is able to apply values of one or more said registers at said faulty points to one or more, respective, said registers at said recovery points.

14. An apparatus according to claim 10, wherein said translator is able to relate one or more of a first set of registers at said faulty points with one or more, respective, registers at said recovery points, and to relate a second set of registers at said faulty points with one or more of said first set of registers through one or more, respective, recovery functions.

15. An apparatus according to claim 14, wherein said translator is able to calculate values of one or more of said first set of registers from said second set of registers, and to apply said values to one or more of said registers at said recovery points, respectively.

16. An apparatus according to claim 10, comprising a look-up table having one or more entries of at least an instruction pointer of said faulty point and an instruction pointer of said recovery point.

17. An apparatus according to claim 10, comprising:
a first look-up table having one or more entries of at least an instruction pointer of said faulty point, an instruction pointer of said recovery point, and a representation identifier; and
a second look-up table having one or more entries of at least said representation identifier, a mapping register, a plurality of representative registers, and a recovery function.

18. A system comprising:
a processor to translate a set of source instructions having one or more recovery points into a set of target instructions having one or more faulty points, which are associated with said one or more recovery points, respectively; and
a memory to store said set of target instructions and said set of source instructions.

19. The system of claim 18, wherein said processor is able to branch out one or more dependency chains of said set of target instructions at one or more of said faulty points, respectively.

20. The system of claim 18, wherein said processor is able to relate one or more of a first set of registers at said faulty points with one or more, respective, registers at said recovery point, and to relate a second set of registers at said faulty points with one or more of said first set of registers through one or more, respective, recovery functions.

21. The system of claim 18, wherein said processor is able to access a look-up table having one or more entries of at least an instruction pointer of said faulty point and an instruction pointer of said recovery point.

22. The system of claim 18, wherein said processor is able to access:
a first look-up table having one or more entries of at least an instruction pointer of said faulty point, an instruction pointer of said recovery point, and a representation identifier; and
a second look-up table having one or more entries of at least said representation identifier, a mapping register, a plurality of representative registers, and a recovery function.

23. A machine-readable medium having stored thereon a set of instructions that, if executed by a machine, result in associating one or more faulty points of a set of target instructions with one or more respective recovery points of a set of source instructions.

24. The machine-readable medium of claim 23, wherein the instructions result in branching out one or more dependency chains of said set of target instructions at one or more of said faulty points, respectively.

25. The machine-readable medium of claim 23, wherein the instructions result in translating said set of source instructions into said set of target instructions.

26. The machine-readable medium of claim 23, wherein the instructions that result in associating result in relating one or more instruction pointers of said faulty points with one or more respective instruction pointers of said recovery points.

27. The machine-readable medium of claim 23 wherein the instructions that result in associating result in relating one or more registers at said faulty points with one or more respective registers at said recovery points.

28. The machine-readable medium of claim 23, wherein the instructions that result in associating result in:
relating one or more of a first set of registers at said faulty points with one or more respective registers at said recovery points; and
relating a second set of registers at said faulty points with one or more of said first set of registers through one or more, respective, recovery functions.

29. The machine-readable medium of claim 28, wherein the instructions result in relating one or more of said recovery functions to one or more representation identifiers.
